(19) United States
(12) Patent Application Publication
(10) Pub. No.: US 2005/0256434 A1
(43) Pub. Date: Nov. 17, 2005

(54) Massage device

(76) Inventor: Xiuqun Luo, Dongguan (CN)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/082,016

(22) Filed: Mar. 16, 2005

(30) Foreign Application Priority Data
May 11, 2004 (CN) 2004200456092

(51) Int. Cl. A61H 7/00

(52) U.S. Cl. 601/86; 601/98; 601/101; 601/103

(57) ABSTRACT

A massage device of the present invention includes a base cover; a guiding device, wherein the guide device comprising a plurality of guiding rails positioned in a middle of the base cover; and a moving base, which suspending above the guiding device; wherein the moving base comprising a bottom and a shield covered thereon to form a compartment; the moving base is mounted on the guiding device in a sleeve form. The moving base comprising power equipment mounted between the bottom and the shield, transmission system and massage system mounted on the shield.

### FIELD OF THE INVENTION

The present invention relates to massage devices with novel structures, and particularly to a massage device using worm to drive worm wheel so as to attain diversiform massage effects.

### BACKGROUND OF THE INVENTION

Conventional massage devices, as disclosed in Taiwan Patent No. 238543 and 435223, generally utilize worm to drive two correspondingly configured worm wheels to rotate relative to each other so as to make kneading components eccentrically coupled on the worm wheels to move circularly to perform massage function. At present, the massage devices are usually assembled on neck-massage parts of massage chairs or presented in an individual massage chair. However, the main drawback of the above-mentioned massage device is that only provide a single massage effect.

Hence, it is desired to provide a massage device to solve the above-mentioned problems.

### SUMMARY OF THE INVENTION

To overcome the above drawbacks of prior art, a main object of the present invention is to provide a massage device which can provide various massage effects.

To attain the above object, a massage device comprises a base cover; a guiding device, wherein the guide device comprising a plurality of guiding rails positioned in a middle of the base cover; and a moving base, which suspending above the guiding device; wherein the moving base comprising a bottom and a shield covered thereon to form a compartment; the moving base is mounted on the guiding device in a sleeve form. The moving base comprising power equipment mounted between the bottom and the shield, transmission system and massage system mounted on the shield.

According to an embodiment of the invention, the moving base further comprising at least one motor; at least one worm on end of the motor; and a plurality of worm wheels joggled with the worm; wherein each of the worm wheel has its top end mounted in a middle shaft bores of the massage system, and has its bottom end sleeved in a first small gear; a big gear is mounted on one side of the first small gear; an intermediary gear is provided for joggling with the big gear and the small gear; a second small gear is provided under the big gear to joggle with a rack; at least one kneading heads mounted on the massage system.

According to another embodiment of the invention, the moving base comprising two motors set in a certain angle; each of motor having at least one worm, at least one worm wheels to joggle with the worm; wherein each of the worm wheel having a first small gear on its bottom, a big gear mounted at side of the first small gear, an intermediary gear to joggle with the big gear and the small gear; a second small gear provided at the big gear and joggling with a rack; the massage system having at least one rotation shelf in which is provided at least one kneading heads. There are two mushroom-shaped kneading heads, which are symmetrically mounted on the rotation shelf; a control circuit is provided in the moving base to control the two kneading heads work individually or coordinately. A plurality of route switches are provided on side of the guide rails. A fix bore is formed on the back of the base cover for inserting a bolt so as to prevent movement of the moving base; a power wire of the massage device has its outer end extending through the bolt and fastened on the bolt.

According to a further embodiment of the invention, the moving base comprises a bottom; a motor in front of the bottom; at least one worm coupled to one end of the motor; at least one worm wheel joggled with and transmitted by the worms; at least one rack provided on side of the guide rail of the bottom; a transmission gear joggled between the worm wheel and the rack; a support plate set on rear of the bottom; at least one bolt shafts positioned on both sides of the support plate; at least one notches for localizing the massage system; and at least one guide rail formed on the moving base. The massage device further comprising: two symmetrical rolling wheels; at least one bracket to connect with the rolling wheels; and at least one bracket sleeve for receiving the bracket.

According to an embodiment of the invention, the moving base comprising at least one support piece with groove formed on its bottom; a bottom on the support piece; a motor positioned on the bottom; at least one worm connecting with one end of the motor; at least one worm wheels joggled with and transmitted by the worm; a transmission gear joggled with the worm wheel; a small gear joggled with the guide rail; an intermediary gear joggled between the small gear and the transmission gear; a media plate, a beating means having two kneading heads, and an eccentric wheel to connect with at least one kneading head provided at the other end of the motor. According to a further embodiment, the moving base comprising: a bottom; a motor mounted on the bottom; at least one worm coupled to one end of the motor; at least one worm wheels joggled with and transmitted by the worm; an intermediary gear joggled between the guide rail and the worm wheel; an eccentric wheel connected on both sides of the worm wheel; a bolt shaft protruded on the eccentric wheel; a rotation plate connected with the bolt shaft in its middle; at least one kneading plate mounted on one end of the rotation plate; a rotation shaft provided on the other end of the rotation plate; a guide block with a guide slot to receive the rotation shaft; at least one grooves formed in the shield for being extended through by the kneading plate. The kneading plate comprising an arc-bended body and a plurality of round rubber plates on the body.

The invention has the following advantages comparing to the prior art as: firstly, through the rotation of the kneading head transmitted by the worm wheel, worm and gear (rack) and movement of the moving base coordinated with guide rail and rack in bottom, curved guide rail made as the outline of people's back can better imitate the motion of manually massage to achieve the imitation effect of manually massage. Kneading and massage effect on different parts of body can make people feel more comfortable. The operation frequency of the massage device can be regulated as required by the person to give a gentle massage effect. The fixed bolt is added to the massage device to prevent the movement of the moving base when it is unused, which make it easy to move, deposit and have a high security to avoid unusual work electricity.

For the purpose of making the invention easier to understand, several particular embodiments thereof will now be described with reference to the appended drawings in which:

### DESCRIPTION OF THE DRAWINGS

FIG. 1 is a perspective view of a moving base with a dual drive motor according to a first embodiment of the invention;

FIG. 2 is a perspective view of a massage device with a dual drive motor according to a first embodiment of the invention;

FIG. 3 is an exploded view of FIG. 1;

FIG. 4 is a perspective view of a massage device with a single drive motor according to a second embodiment of the invention;

FIG. 5 is an exploded, perspective view of a moving base with a single drive motor according to a second embodiment of the invention;

FIG. 6 is an assembled view of the moving base of FIG. 5;

FIG. 7 is a schematic view to show operation of the massage device of FIG. 4;

FIG. 8 is a perspective view of a massage device according to a third embodiment of the invention;

FIG. 9 is an exploded view of FIG. 8;

FIG. 10 is a perspective view of a massage device according to a fourth embodiment of the invention;

FIG. 11 is an exploded view of FIG. 10;

FIG. 12 is a perspective view of a massage device according to a five embodiment of the invention;

FIG. 13 is an exploded view of FIG. 12; and

FIG. 14 is a perspective view of a shield of the massage device of FIG. 12.

### DETAILED DESCRIPTION OF THE INVENTION

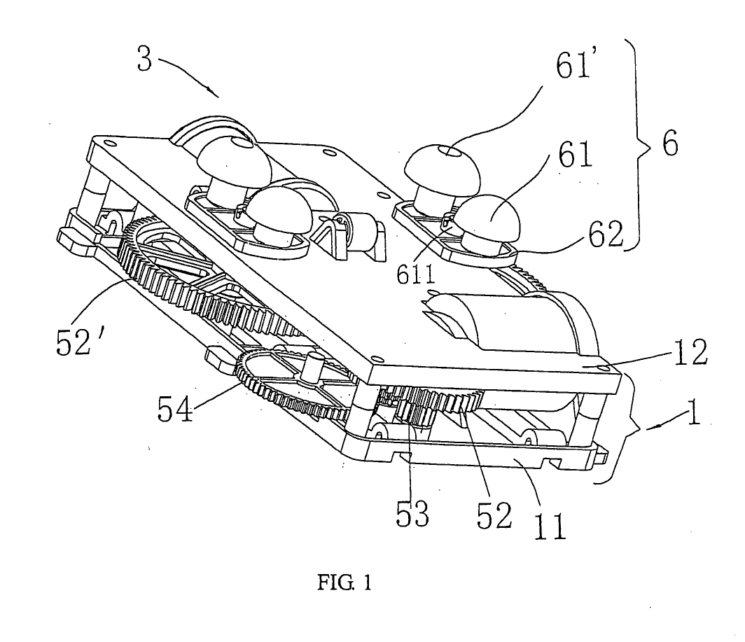

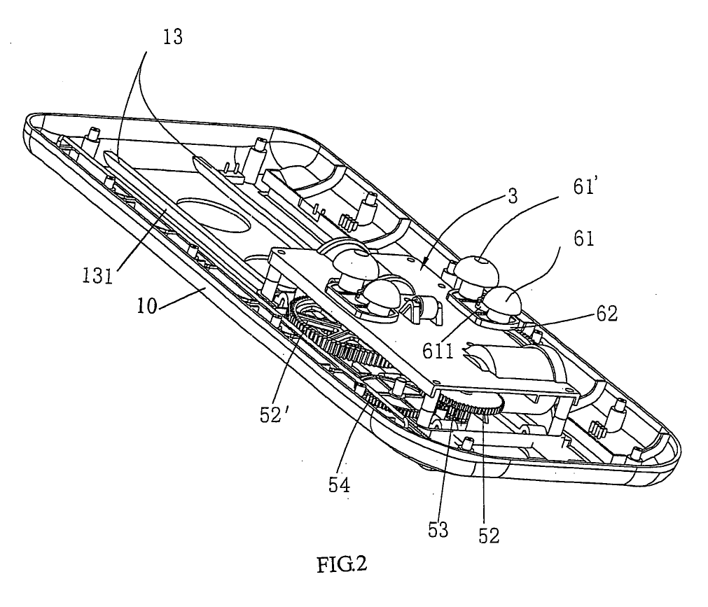

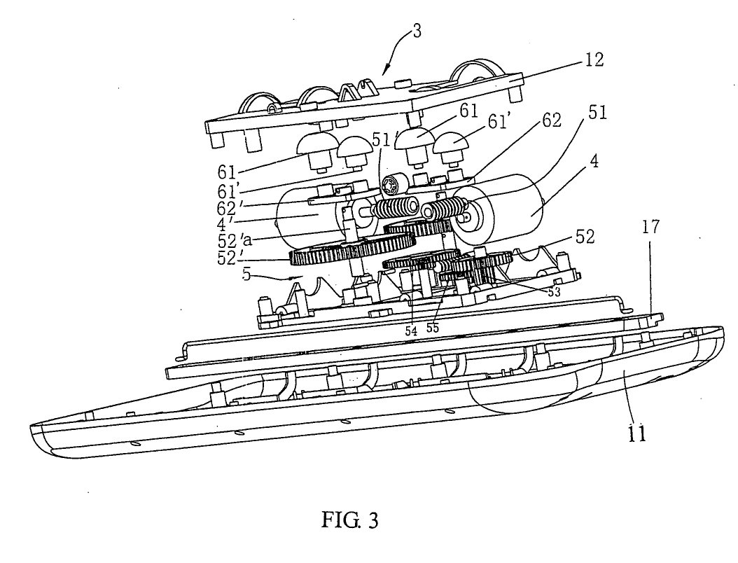

Referring to FIGS. 1-3, according to a first embodiment of the invention, a massage device comprises a base cover 10, a guide device 13 and a moving base 3. The guide device 13 is constituted by a plurality of guide rails 131 positioned in the middle of the base cover 10. The moving base 3 comprises a bottom 11 and a shield 12. The shield 12 covers on the bottom 11 so as to form a chassis 1. Two motors 4 and 4′ are assembled between the bottom 11 and the shield 12; a transmission system 5 and a massage system 6 positioned on the shield 12. The moving base 3 is suspended above the guide device 13 and can move in an area defined by the guide device 13. In the invention, the motors 4 and 4′ are set in a certain angle, which are provided with worm 51 and 51′ on its output end. Two worm wheels 52 and 52′ are joggled with and drived in-phase by the worm 51 and 51′ of the motor 4 and 4′ respectively. The two worm wheels 52 and 52′ are pivoted in the moving base 3 comparatively. Each of worm wheel shafts 52′a of the worm wheels 52 and 52′ has its top end mounted in a corresponding middle shaft bore 611 of each rotation shelve 62 of the massage system 6, and has its bottom end sleeved in a small gear 53. Also, a big gear 54 for transmission is mounted on one side of the small gear 53. An intermediary gear 55 is provided for joggling with the big gear 54 and the small gear 53. In addition, anther small gear is provided under the big gear 54 to joggle with a rack 17. Two kneading head 61 and 61′ are mounted in each of the rotation shelves 62, which are symmetrically provided on both sides of the middle shaft bores 611. In an embodiment, each of the kneading heads 61 and 61′ have a shape of mushroom.

During operation, firstly, power is supplied for the motors 4 and 4′; then the motor 4 and 4′ are driven to rotate so as to drive a first transmission system consisting of the worm 51 and the worm wheel 52, and a second transmission system consisting of the worm 51′ and the worm wheel 52′. The worms 51, 51′ are connected with the motors 4, 4′ and drive the worm wheels 52, 52′ to rotate on both sides thereof. In the invention, the rotation shelves 62, 62′ are rotated along with the worm wheels 52, 52′ due to being fixed thereon. Then, the kneading heads 61, 61′ on the rotation shelves 62 and 62′ are rotated along with the rotation of rotation shelves 62 and 62′. In the meantime, the kneading heads 61, 61′ are rotated by themselves. When a person has its back rested on the kneading heads 61, 61′, he will have a feeling of back-kneading by people's fingers. In the embodiment, because the two worm wheels 52 and 52′ rotate in counter-direction, and the kneading heads 61, 61′ are comparatively set on the rotation shelves 62, 62′, the pressure exerted to the person can be changed so as to achieve an imitated manual massage effect. When the worm wheel 52 rotates, another worm wheel 52′ is transmitted with speed-down to the big gear 54 through the small gear 53 and the intermediary gear 55. The small gear above the big gear 54 is joggled with the rack 17 in the bottom 1 so as to drive the moving base 3 move on back of person and attain an imitated way of manual massage. The guide rail 131 is used for guiding the moving base 3 and making its movement smoothly. The two motors 4, 4′ are controlled by circuit of the massage device to make them both or solely work, thus achieving various massage effects.

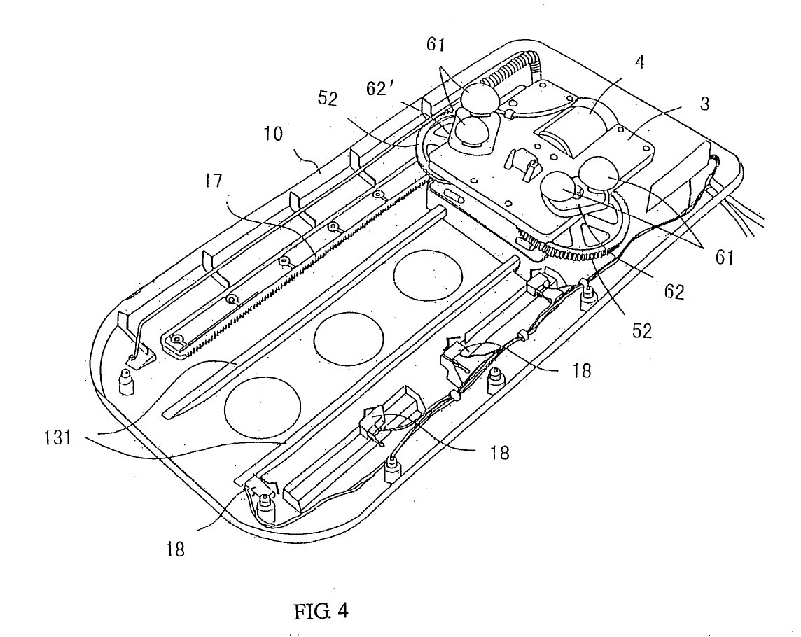

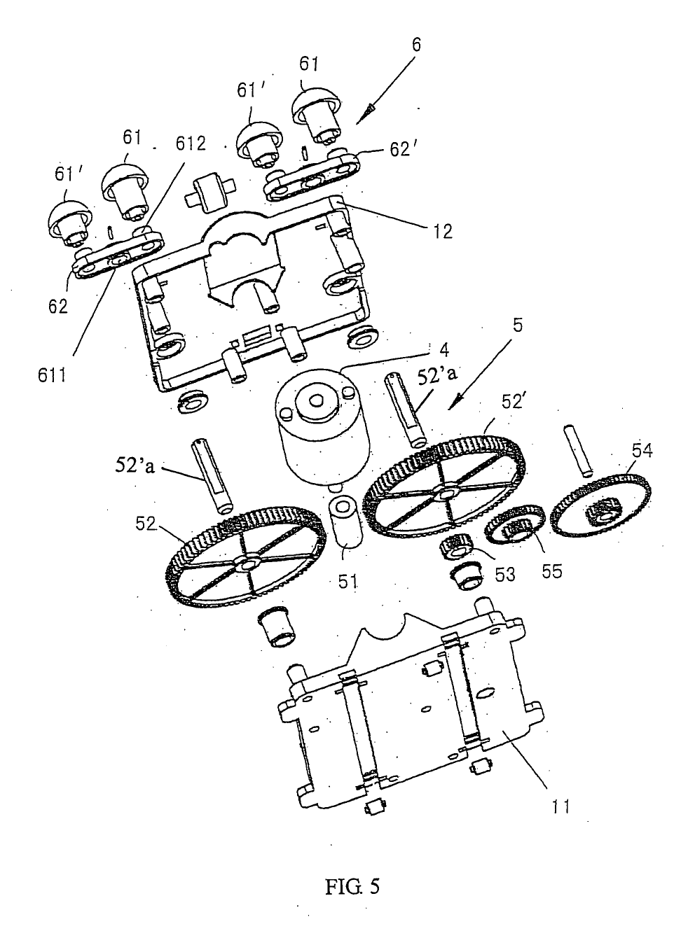

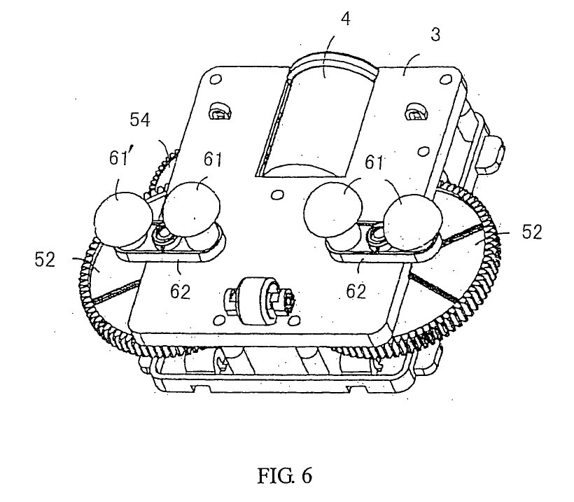

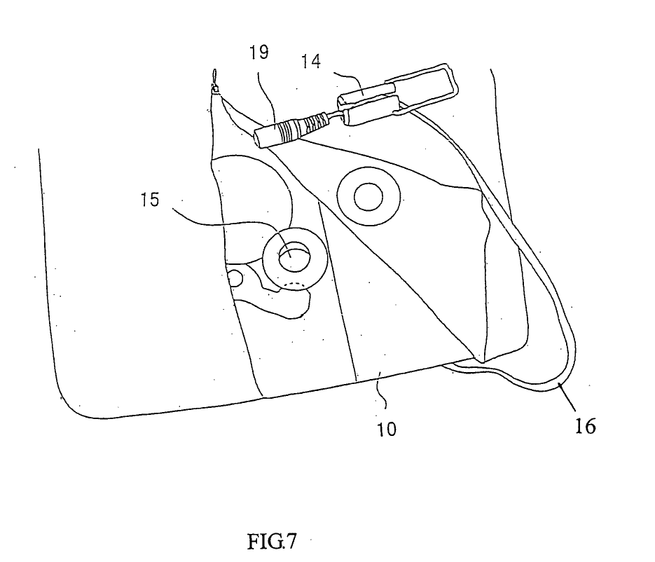

As shown in FIGS. 4-6, according to a second embodiment of the invention, a massage device comprises a base cover 10, a guide device 13 and a moving base 3. The moving base 3 comprises a bottom 11 and a shield 12 covered thereon so as to form a chassis. The guide device 13 is constituted by a plurality of guide rails 131 positioned in the middle of the base cover 10. The moving base 3 comprises a single motor 4 which is assembled between the bottom 11 and the shield 12; a transmission system 5 and a massage system 6 positioned on the shield 12. The moving base 3 is suspended above the guide device 13 and can move in an area defined by the guide device 13. In the invention, the motor 4 is provided with worm 51 on its output end. Two worm wheels 52 and 52′ are joggled with and drived in-phase by the worm 51 of the motor 4. The two worm wheels 52 and 52′ are pivoted in the moving base 3 comparatively. Each of worm wheel shafts 52′a of the worm wheels 52, 52′ has its top end mounted in a middle shaft bore 611 of each rotation shelves 62, 62′ of the massage system 6. Two kneading head 61 and 61′ are mounted on two fixers 612 which are symmetrically provided on both sides of the middle shaft bores 611. The kneading heads 61 and 61′ have a shape of mushroom. A fix bore 15 is formed on the back of the base cover 10 for inserting a bolt 14 so as to prevent movement of the moving base 3. Power wire 16 of the massage device has its outer end extending through the middle bore of the bolt 14 and fastened on inner end of the bolt 14. During operation, the bolt 14 must be pulled out firstly to restore the status of free movement of the moving base 3, and then power supply can be provided so as to avoid accidents. In the embodiment, a shield block 19 is provided on back of the bottom 11 corresponding to the bolt 14. When the bolt 14 being pulled out, the shield block 19 will cover the fix bore 15 automatically under the press of spring means. This will prevent any other things falling into the fix bore 15 and affect the movement of the moving base 3. The rotation shelves 62 are positioned at the wheel shafts 52′a of the worm wheels 52. In the embodiment, a worm wheel 52′ is connected with a small gear 53. The small gear 53 is joggled with an intermediary gear 55. The worm wheel 52′ is transmitted with speed-down to the big gear 54 through the small gear 53 and the intermediary gear 55. In addition, anther small gear is provided under the big gear 54 to joggle with a rack 17. In the embodiment, several route switches 18 are set along the moving route of the moving base 3 in the base cover 10. The route switch 18 can make the moving base 3 stay at different positions for massaging different body portion conveniently.

During operation, firstly, power is supplied for the motor 4 and then the motor 4 is driven to rotate so as to drive a transmission system with worms and worm wheels. That is, the worms 51 is connected with the motor 4 and drive the worm wheels 52, 52′ on both sides thereof to rotate. In the invention, the rotation shelves 62, 62′ are rotated along with the worm wheel 52, 52′ due to being fixed thereon. Then, the kneading heads 61, 61′ on the rotation shelves 62 and 62′ are rotated along with the rotation of the rotation shelves 62 and 62′. In the meantime, the kneading heads 61, 61′ are rotated by themselves. When a person has its back rested on the kneading heads 61, 61′, he will have a feeling of back-kneading by people's fingers. In the embodiment, because the two worm wheels 52 and 52′ rotate in counter-direction, and the kneading heads 61, 61′ are comparatively set on the rotation shelves 62, 62′, the pressure exerted to the person can be changed so as to achieve an imitated manual massage effect. When the worm wheel 52 rotates, another worm wheel is transmitted with speed-down to the big gear 54 through the small gear 53 and the intermediary gear 55. The small gear above the big gear 54 is joggled with the rack 17 in the bottom 11 so as to drive the moving base 3 move on back of person and attain an imitated way of manual massage. The guide rail 131 is used for guiding the moving base 3 and making its movement smoothly.

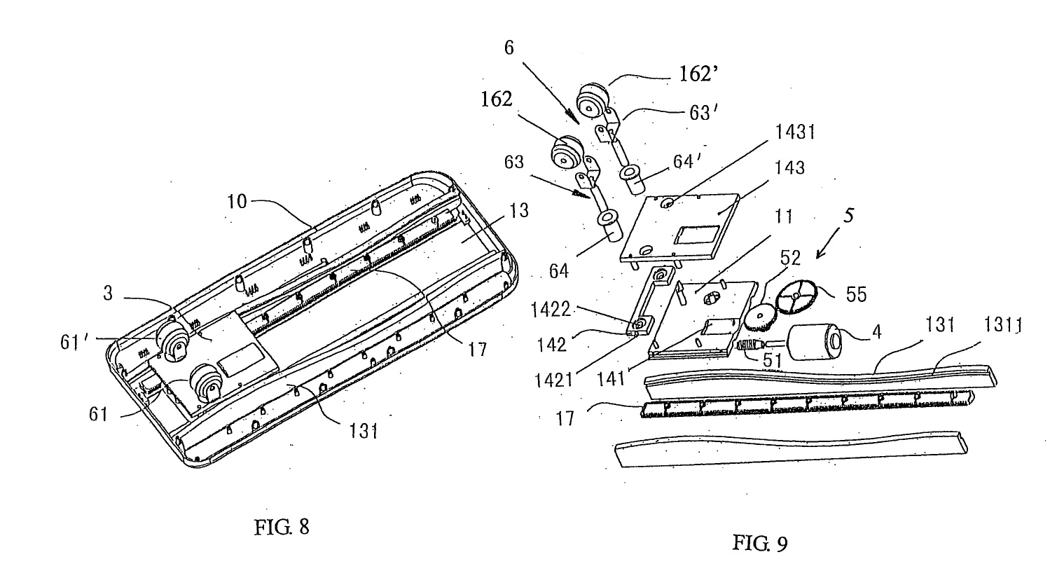

As shown in FIGS. 8-9, according to a third embodiment of the invention, a massage device comprises a base cover 10, a guide device 13 and a moving base 3. The moving base 3 comprises a bottom 11 and a shield 12 covered thereon so as to form a chassis. The guide device 13 is constituted by a plurality of guide rails 131 positioned in the middle of the base cover 10. The moving base 3 comprises a single motor 4 which is assembled between the bottom 11 and the shield 12; a transmission system 5 and a massage system 6 positioned on the shield 12. The moving base 3 is suspended above the guide device 13 and can move in an area defined by the guide device 13. In the embodiment, the motor 4 is mounted in a groove 141 at front end of the bottom 11. The moving base 3 further comprises a guide rail 131 with a rail groove 1311, a worm 51 on the output end of the motor 4, a worm wheels 52, a rack 17 provided on side of guide rail 131. The worm wheel 52 is joggled with and drived by the worm 51. The moving base 3 still comprises an intermediary gear 55 and a support piece 142. The intermediary gear 55 is joggled between the worm wheel 52 and the rack 17. The support piece 142 is provided on rear of the bottom 11, both sides of which have two bolt shafts 1421 protruded in the rail groove 1311 and move therein. Two notches 1422 are provided both ends of top portion of the support piece 142 for pitch of the massage system 6. The kneading heads 61, 61′ are positioned on a top plate 143 of the moving base 3. The massage system 6 comprises two rolling wheels 162, 162′ in symmetry, two brackets 63 and 63′ hinged with the rolling wheels 162, 162′ and two bracket sleeves 64, 64′. The rolling wheels 162, 162′ can be made in different shapes, such as column or gear. The main shafts of the brackets 63, 63′ extend through through-holes 1431 of the top plate 143 of the moving base 3, and being fixed on the support piece 142 below the top plate 143. The support piece 142 is removable and the kneading head 61 and 61′ can move up-and-down together with the support piece 142. The guide rail 131 has a curve similar to human body curve, which is provided at outer side of the rack 17. Also, a curved groove 1311 is formed in a side of the guide rail 131 adjacent to the rack 17. The bolt shafts 1421 are engaged in the rail groove 1311 of the guide rail 131.

During operation, after start-up of the motor 4, the worm 51 makes transmission to the intermediary wheel 55, and the intermediary wheel 55 moves back-and-forward relative to the rack 17. Because the intermediary wheel 55 is fixed on the moving base 3, so the moving base 3 also moves back-and-forward along the rack 17 at the same time. In addition, because the rack 17 is joggled with the intermediary wheel 55, so the moving base 3 will not sway when moving back-and-forward. In a further embodiment, a groove can be formed on a bottom plate of the moving base 3, and a corresponding rail can be set on the bottom 11 so that the moving base 3 is more stably during movement. At that moment, the kneading head 61, 61′ will move together with the moving base 3. The support piece 142 moves along the rail grooves 1311 of the guide rails 131. Because the groove 1341 is curved, so the kneading head 61 and 61′ have a curved movement along human body curve and do a massage. In addition, the rolling wheels 162 and 162′ can rotate automatically to a best angle and will not get jammed. Thus the user do not have to sit straight intentionally, while sitting at ease and get a best massage effect. Furthermore, the bolt shafts 1421 can be replaced by a groove and the guide rail 131 is embedded in the groove so as to improve the stability of movement of the moving base 3. Understandably, it can provide protruded teeth (not shown) on the guide rail 131 to replace the rack 17.

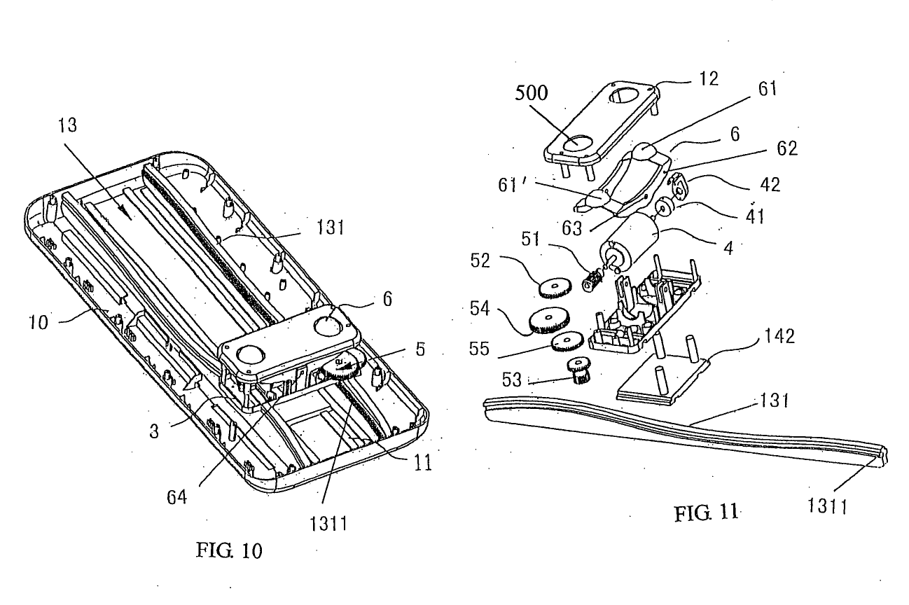

As shown in FIGS. 10-11, according to a fourth embodiment of the invention, a massage device comprises a base cover 10, a guide device 13 and a moving base 3. The moving base comprises a bottom 11 and a shield 12 covered thereon so as to form a chassis. The guide device 13 is constituted by a plurality of guide rails 131 positioned in the middle of the base cover 10. The moving base 3 comprises a single motor 4 which is assembled between the bottom 11 and the shield 12; a transmission system 5 and a massage system 6 positioned on the shield 12. The moving base 3 is suspended above the guide device 13 and can move in an area defined by the guide device 13. The moving base 3 further comprises a support piece 142. A rail groove 1311 is formed in the guide rail 131 which symmetrically positioned at a bottom of the support piece 142. In the embodiment, the bottom 11 is mounted on the support piece 142, and the motor 4 mounted on the bottom 11. A worm 51 is provided on the front output end of the motor 4; a worm wheel 52 are provided to joggle with and drived by the worm 51. A big gear 54 is provided to joggle with the worm wheel 52. A small gear 53 is provided to joggle with the rail groove 1311 of the guide rail 131. An intermediary gear 55 is provided to joggle with the small gear 53 and the big gear 54. On the back output end of the motor 4 there are a media plate 41, an eccentric wheel 42, and a beating means 6. The beating means 6 comprises two kneading heads 61 and 61′ which are connected like a teeterboard. The beating means 6 has an arc-shaped connecting rod 62. A through-hole 63 is formed in the connecting rod 62. A cross shaft 64 extends through the through-hole 63 to be fixed on the bottom 11 of the moving base 3. The beating means 6 can swing left-and-right around the cross shaft 64. The guide rail 131 has a curve similar to human body curve, which is mounted on the bottom 11. The small gear 53 is joggled with the rail groove 1311 of the guide rail 131.

During operation, after start-up of the motor 4, an output end of the motor 4 drives the worm 51 and then the worm wheel 52 to rotate. The big gear 54 is bigger than the worm wheel 52 so as to achieve a function of speed-down due to high-speed rotation of the motor 4. T small gear 53 is joggled with the rail groove 1311 of the guide rail 131 so as to make the moving base 3 to do multiple movement, one of which is a planar movement along the base cover 10; the other is a vertical movement. In the embodiment, another output end of the motor 4 drives the media plate 41 to rotate so as to make the eccentric wheel 42 do a multiple movement with up-and-down vibration and left-and-right swing. In addition, because the eccentric wheel 42 is connected with the beating means 6, so the massage device will do a multiple movement with an up-and-down vibration around a centric shaft thereof and a horizontal swing. A shield 12 is provided on the beating means 6, which is fixed on the moving base 3. Also, two through-openings 500 are formed on the shield 12 corresponding to the kneading heads 61 and 61′ so that the kneading heads 61 and 61′ can extend through the through-openings to perform massage function. In the embodiment, there are two ways to improve the moving stability of the moving base 3. The first way is that forming a hole on bottom portion of the moving base 3, and forming a groove on the bottom 11 which can receive the rolling wheels with straight rod, the straight rod mounting in the hole of the moving base 3. The second way is that forming a hole on bottom portion of the moving base 3, and forming a rack on the bottom 11, forming a support piece 142 with a groove on the bottom of the moving base 3 corresponding to the rack; the rack engaging with the groove; the support piece 142 also having a straight rod 1421 to mount in the hole of the bottom of the moving base 3. Due to the curve-shaped guide rail 131, the user do not have to sit straight intentionally, but just sit at ease. The curvilinear movement of the moving base 3 can make the beating means 6 to beat human body, such as back.

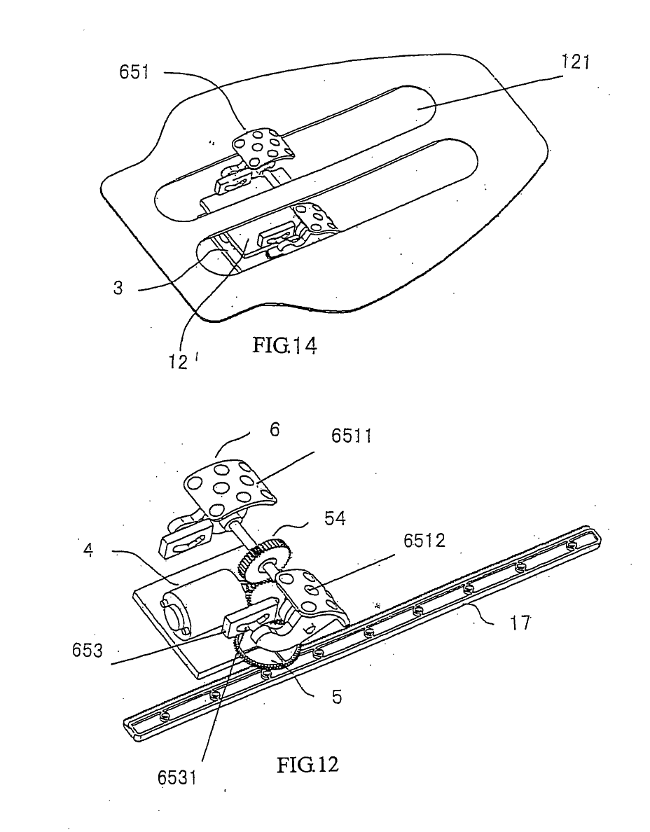

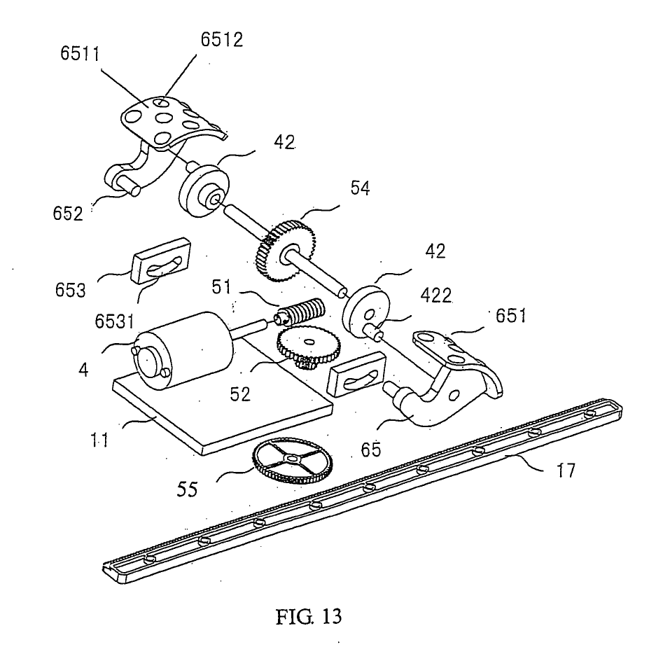

As shown in FIGS. 12-14, according to a five embodiment of the invention, a massage device comprises a base cover (similar to the base cover in the above-mentioned embodiments, not shown), a guide device 13 and a moving base 3. The moving base 3 comprises a bottom 11 and a shield 12 covered thereon so as to form a chassis. The guide device 13 is constituted by a plurality of guide rails (similar to the base cover in the above-mentioned embodiment, not shown) positioned in the middle of the bottom 11. The moving base 3 comprises a motor 4 which is assembled between the bottom 11 and the shield 12; a transmission system 5 and massage system 6 positioned on the shield 12. The moving base 3 is suspended above the guide device 13 and can move in an area defined by the moving base 3. The moving base 3 further comprises a worm 51 on the output end of the motor 4, a worm wheel 52, a rack 17 provided on side of the guide rail. The worm wheel 52 is joggled with and drived by the worm 51. The moving base 3 still comprises a small gear 53 which is joggled between the worm wheel 52 and the rack 17. An eccentric wheel 42 is connected with both ends of the worm wheel 54. The eccentric wheel 42 has a bolt shaft 422 protruded at the eccentricity of the eccentric wheel 42. A rotation plate 65 is connected with the bolt shaft 422 in its middle, which has a kneading plate 651 fixed on one end thereof. The kneading plate 651 comprises an arc-bended body 6511 and a plurality of round rubber plates 6512. The rotation plate 65 comprises a rotation shaft 652 extending from another end thereof. The rotation shaft 652 is engaged into a crescent-shaped guide slot 6531 which is formed in the middle of a guide block 653. Two grooves 121 is symmetrically formed in the shield 12 for being extended through by the kneading plates 651. The motor 4 has an output end to connect with a worm 51. The worm 51 is joggled with the worm wheel 52 and the big gear 54. The small gear 53 is fixed on the worm wheel 52 to joggle with the big gear 54. Because of high-speed rotation of the motor 4 and a contact process during massage, a multilevel gear transmission is provided for speeding down. The rubber plates 6512 can use for massaging human body point. The rotation plate 65 substantially connects with the kneading plates 651 vertically. The eccentric wheel 42 has a bolt shaft 422 so as to make the kneading plates 651 rotate along with the eccentric wheel 42. Due to the joint of bolt shaft 422 with the rotation plate 65 does not lie in a same line so that it is very difficult to make the kneading plate 651 move back-and-forth in a curve groove 6531. To let the two kneading plates 651 can reach their peak in sequence and massage human body, the eccentric wheel 42 can be adjusted to make their rotate axis at different height, and at the same time the kneading plates 651 can be adjusted to embed the bolt shaft 422 in the curve groove 6531 of the guide block 653 steadily.

During operation, the motor 4 drives the worm 51 to rotate and then the worm 51 drives the transmission system 5 to rotate. The transmission system 5 slows down the rotation speed of the moving base 3 by small gear 53 of the worm wheel 51, small gear of the worm wheel 52 and the intermediary gear 55. Thus making the moving base 3 move along the rack normally. The eccentric wheel 42 drives the two kneading plates 651. Because the bolt shaft 422 is embedded in the curve groove 6531 of the guide block 653, the two kneading plates 651 do not do circle movement for being constrained, but do a back-and-forth movement along an arc line like the shape of the curve groove 6531. The rotation axis of the eccentric wheel 42 is mounted in the hole of the rotation plate 65, so it won't get jammed. In this way, the two kneading plates 651 massage human body in turn as a manual “back treading”. To improve the moving stability of the moving base 3, a guide rail 131 can be provided on the bottom 11 and a groove provided on bottom plate of the bottom 11 where the guide rail 131 is embedded in (not shown)

It is understood that the invention may be embodied in other forms without departing from the spirit thereof. Thus, the present examples and embodiments are to be considered in all respects as illustrative and not restrictive, and the invention is not to be limited to the details given herein.

1. A massage device comprising:
a base cover;
a guiding device, wherein the guide device comprising a plurality of guiding rails positioned in a middle of the base cover; and
a moving base, which suspending above the guiding device; wherein the moving base comprising a bottom and a shield covered thereon to form a compartment;
the moving base is mounted on the guiding device in a sleeve form.

2. The massage device as claimed in claim 1, wherein the moving base comprising power equipment mounted between the bottom and the shield, transmission system and massage system mounted on the shield.

3. The massage device as claimed in claim 2, wherein the moving base further comprising:
at least one motor;
at least one worm on end of the motor; and
a plurality of worm wheels joggled with the worm;
wherein each of the worm wheel has its top end mounted in a middle shaft bores of the massage system, and has its bottom end sleeved in a first small gear; a big gear is mounted on one side of the first small gear; an intermediary gear is provided for joggling with the big gear and the small gear; a second small gear is provided under the big gear to joggle with a rack; at least one kneading heads mounted on the massage system.

4. The massage device as claimed in claim 2, wherein the moving base comprising:
two motors set in a certain angle;
each of motor having at least one worm, at least one worm wheels to joggle with the worm;
wherein each of the worm wheel having a first small gear on its bottom, a big gear mounted at side of the first small gear, an intermediary gear to joggle with the big gear and the small gear; a second small gear provided at the big gear and joggling with a rack;
the massage system having at least one rotation shelf in which is provided at least one kneading heads.

5. The massage device as claimed in claim 4, wherein there are two mushroom-shaped kneading heads, which are symmetrically mounted on the rotation shelf; a control circuit is provided in the moving base to control the two kneading heads work individually or coordinately.

6. The massage device as claimed in claim 2, wherein a plurality of route switches are provided on side of the guide rails.

7. The massage device as claimed in claim 5, wherein a fix bore is formed on the back of the base cover for inserting a bolt so as to prevent movement of the moving base; a power wire of the massage device has its outer end extending through the bolt and fastened on the bolt.

8. The massage device as claimed in claim 2, wherein the moving base comprises a bottom;
a motor in front of the bottom;
at least one worm coupled to one end of the motor; at least one worm wheel joggled with and transmitted by the worms;
at least one rack provided on side of the guide rail of the bottom;
a transmission gear joggled between the worm wheel and the rack;
a support plate set on rear of the bottom;
at least one bolt shafts positioned on both sides of the support plate;
at least one notches for localizing the massage system; and
at least one guide rail formed on the moving base.

9. The massage device as claimed in claim 2, wherein the massage device further comprising:
two symmetrical rolling wheels;
at least one bracket to connect with the rolling wheels; and
at least one bracket sleeve for receiving the bracket.

10. The massage device as claimed in claim 2, wherein the moving base comprising:
at least one support piece with groove formed on its bottom;
a bottom on the support piece;
a motor positioned on the bottom;
at least one worm connecting with one end of the motor;
at least one worm wheels joggled with and transmitted by the worm;
a transmission gear joggled with the worm wheel;
a small gear joggled with the guide rail;
an intermediary gear joggled between the small gear and the transmission gear;
a media plate, a beating means having two kneading heads, and an eccentric wheel to connect with at least one kneading head provided at the other end of the motor.

11. The massage device as claimed in claim 2, wherein the moving base comprising:
a bottom;
a motor mounted on the bottom;
at least one worm coupled to one end of the motor;
at least one worm wheels joggled with and transmitted by the worm;
an intermediary gear joggled between the guide rail and the worm wheel;
an eccentric wheel connected on both sides of the worm wheel;
a bolt shaft protruded on the eccentric wheel;
a rotation plate connected with the bolt shaft in its middle;
at least one kneading plate mounted on one end of the rotation plate;
a rotation shaft provided on the other end of the rotation plate;
a guide block with a guide slot to receive the rotation shaft;
at least one grooves formed in the shield for being extended through by the kneading plate.

12. The massage device as claimed in claim 11, wherein the kneading plate comprising an arc-bended body and a plurality of round rubber plates on the body.
